(19) United States
(12) Patent Application Publication
(10) Pub. No.: US 2024/0134815 A1
(43) Pub. Date: Apr. 25, 2024

(54) SYSTEMS AND METHODS FOR GRAPHICALLY PROGRAMMING AN APPLICATION WITH EXTERNAL INTEGRATED CIRCUITS

(71) Applicant: Mohammad Ali Rezaei, Medford, MA (US)

(72) Inventor: Mohammad Ali Rezaei, Medford, MA (US)

(21) Appl. No.: 18/277,655

(22) PCT Filed: Mar. 8, 2022
(86) PCT No.: PCT/US2022/019306

§ 371 Date: Aug. 16, 2023

Related U.S. Application Data
(60) Provisional application No. 63/158,344, filed on Mar. 8, 2021.

(51) Int. Cl. G06F 13/42; G06F 9/451

(52) U.S. Cl. CPC G06F 13/4221; G06F 9/451

(57) ABSTRACT

A microcontroller, including an input/output pin in communication with an external circuit and a processor in communication with the external circuit through the I/O pin, the processor configured to run a RTOS comprising code that causes the processor to communicate with the external circuit to perform operations. A computerized method that cause a processor to execute a graphical programming environment for creating an executable computer program for execution by a microcontroller in communication with an external circuit, the graphical programming environment comprising a GUI for graphically specifying at least a portion of the computer program, display, a first and second graphical component of a graphical program in the graphical user interface specifying a first and second operation of the microcontroller, and display a link between the first and second graphical component in the GUI to specify how the first and second operation relate for interfacing with the external circuit.

### CROSS-REFERENCE TO RELATED APPLICATIONS

This application claims the benefit under 35 U.S.C. § 119(e) of U.S. Provisional Patent Application Ser. No. 63/158,344, filed Mar. 8, 2021, under Attorney Docket No. R0855.70000US00 and entitled “SYSTEMS AND METHODS FOR GRAPHICALLY PROGRAMMING AN APPLICATION WITH EXTERNAL INTEGRATED CIRCUITS,” which is hereby incorporated by reference herein in its entirety.

### BACKGROUND

An embedded system is a computer system, including a processor, memory and input/output peripherals that has one or more dedicated functions. Software engineers often write programs to configure embedded systems, also referred to as microcontrollers, to perform specific tasks. Microcontrollers are often incorporated within larger systems, such as larger electrical or electro-mechanical systems. Microcontrollers are therefore often used in combination with external circuitry to perform various functions. In particular, microcontrollers are often used to control and monitor various electro-mechanical systems, which necessitates the ability to communicate with the external hardware. Software engineers must therefore typically write custom code to interface a microcontroller with external circuitry, which requires the engineers to, for example, keep track of the states of and receive feedback from the external hardware, as well as issue proper commands in order to successfully control the external hardware.

### SUMMARY

The techniques described herein provide for visual programming environments that allow a user to program a microcontroller quickly and efficiently to interface with external circuitry. In some embodiments, a graphical programming environment is provided that allows a user to program both the functionality of a microcontroller as well as interactions of the microcontroller with external circuitry and/or peripherals. In some embodiments, the techniques provide for an operating system that includes an abstraction layer or thread that is used to implement functions that interface with the external circuitry (e.g., initializing the external circuitry, transmitting data to the external circuitry, receiving data from the external circuitry, etc.). These and other aspects are described further herein.

Some aspects relate to a microcontroller. The microcontroller has an input/output (I/O) pin in electrical communication with an external circuit and a processor in communication with the external circuit through the I/O pin, wherein the processor is configured to run a real time operating system and the real time operating system comprises a portion of code that causes the processor to communicate with the external circuit through the I/O pin to perform one or more operations with the external circuit.

According to some embodiments, the portion of code may comprise an abstraction layer that abstracts at least a portion of operation of the external circuit to communicate with the external circuit through the I/O pin to perform the one or more operations, a thread to communicate with the external circuit through the I/O pin to perform the one or more operations, or a combination thereof.

According to some embodiments, the one or more operations may include initializing the external circuit for operation, controlling a state of the external circuit while the external circuit is running, using the external circuit to perform the one or more operations, or a combination thereof.

According to some embodiments, the processor may be in communication with the external circuit through an I/O pin.

According to some embodiments, the processor may be in communication with the external circuit through a communication peripheral. The communication peripheral may implement a communication protocol comprising one of Serial Peripheral Interface (SPI), Inter-integrated-circuit (I2C), System Management Bus (SMB), Controller Area Network (CAN), Universal Asynchronous Reception and Transmission (UART), or Universal Synchronous/Asynchronous Receiver/Transmitter (USART).

According to some embodiments, the portion of code may further cause the processor to perform the one or more operations with one or more peripherals of the processor.

Some aspects relate to a non-transitory computer-readable media comprising instructions that, when executed by one or more processors on a computing device, are operable to cause the one or more processors to execute the real time operating system.

Some aspects relate to a method comprising executing a real time operating system, wherein the real time operating system comprises a portion of code configured to cause one or more processors to communicate with an external circuit through an I/O pin to perform one or more operations with the external circuit.

Some aspects relate to a non-transitory computer-readable media comprising instructions that, when executed by one or more processors on a computing device, are operable to cause the one or more processors to execute a portion of code for a real time operating system that causes the processor to communicate with an external circuit through an input/output (I/O) pin to perform one or more operations with the external circuit.

Some aspects relate to a computerized method for execution by a computing device comprising at least one processor and memory configured to store instructions that, when executed by the at least one processor, cause the at least one processor to execute a graphical programming environment for creating an executable computer program for execution by a microcontroller in communication with an external circuit, wherein the graphical programming environment comprises a graphical user interface for graphically specifying at least a portion of the computer program; display, in response to first input, a first graphical component of a graphical program in the graphical user interface, wherein the first graphical component specifies a first operation of the microcontroller; display, in response to second input, a second graphical component of the graphical program in the graphical user interface, wherein the second graphical component specifies a second operation for interfacing with the external circuit; and display, in response to third input, a link of the graphical program between the first graphical component the second graphical component in the graphical user interface to specify how the first operation of the microcontroller relates to the second operation for interfacing with the external circuit.

According to some embodiments, a user, using the graphical user interface, may copy a first graphical component of a graphical program into a second graphical program.

According to some embodiments, one or more files and/or data structures storing the first and/or second graphical components are uploaded to and/downloaded from a remote server via an online platform.

According to some embodiments, the method may further comprise generating, based on the graphical program, human readable code configured to be compiled to generate the executable computer program for execution by the microcontroller, wherein the executable computer program comprises machine code.

According to some embodiments, a first portion of the executable computer program associated with the first graphical component may comprise a first thread. A second portion of the executable computer program associated with the second graphical component may comprise a second thread.

According to some embodiments, the executable computer program may be configured to, when executed by the microcontroller, generate a real time operating system comprising an abstraction layer that abstracts at least a portion of operation of the external circuit to communicate with the external circuit through an I/O pin to perform the one or more operations, a thread to communicate with the external circuit through the I/O pin to perform the one or more operations, or a combination thereof.

According to some embodiments, the executable computer program may be configured to, when executed by the microcontroller, cause the processor to interface with the external circuit by performing one or more operations with the external circuit. The one or more operations may comprise initializing the external circuit for operation; controlling the one or more operations of the external circuit; managing a physical aspect of the external circuit; and using the external circuit to perform the one or more operations; or a combination thereof.

According to some embodiments, the method may further comprise using a remote server in communication with the graphical programming environment, to generate, based on the graphical program, the executable computer program for execution by the microcontroller.

Some aspects relate to a non-transitory computer-readable media comprising instructions that, when executed by one or more processors on a computing device, are operable to cause the one or more processors to execute a real time operating system comprising an abstraction layer that abstracts at least a portion of operation of an external circuit through an I/O pin to perform one or more operations; a thread to communicate with the external circuit through the I/O pin to perform the one or more operations; or a combination thereof.

Some aspects relate to a system comprising a memory storing instructions, and a processor configured to execute the instructions to execute a real time operating system comprising an abstraction layer that abstracts at least a portion of operation of an external circuit through an I/O pin to perform one or more operations; a thread to communicate with the external circuit through the I/O pin to perform the one or more operations; or a combination thereof.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 is a block diagram of an exemplary microcontroller, according to some embodiments.

FIG. 2 is an exemplary diagram of an operation of an RTOS, according to some embodiments.

FIG. 3A is an exemplary diagram of an RTOS stack.

FIG. 3B is an exemplary diagram of an RTOS stack including hardware controllers, according to some embodiments.

FIG. 4 is an exemplary diagram of a preemptive scheduling GUI.

FIG. 5 is an exemplary image of a main page of an application, according to some embodiments.

FIG. 6 is an exemplary diagram of a thread in an application window, according to some embodiments.

FIG. 7 is an exemplary diagram of threads in an application window, according to some embodiments.

FIG. 8 is an exemplary diagram of a thread comprising states in an application window, according to some embodiments.

FIG. 9 is a flowchart of an exemplary method, according to some embodiments.

FIG. 10 is an exemplary diagram of threads in an application window, according to some embodiments.

FIG. 11 is an exemplary diagram of a thread with different state machines in an application window, according to some embodiments.

FIG. 12 is an exemplary diagram of a module in an application window, according to some embodiments.

FIG. 13 is an exemplary diagram of a module in an application window, according to some embodiments.

FIG. 14 is a block diagram of a cloud-connected system, according to some embodiments.

FIG. 15 is an exemplary state machine, according to some embodiments.

FIG. 16 is exemplary code generated using the state machine of FIG. 15, according to some embodiments.

### DETAILED DESCRIPTION

As described above, embedded systems may include one or more processors, memories and input/output peripherals that have one or more dedicated functions within a larger computer-based system. It is not uncommon, therefore, for embedded systems to interface with various external integrated circuits or other peripherals that are part of the larger system. Programs can be written for embedded processors to cause the processors and external circuitry/peripherals to perform specific tasks. Examples of such external peripherals include, for example, display drivers (e.g., LCD drivers), temperature sensors, communication components (e.g., Wi-Fi, Bluetooth, etc.), and/or any other external circuitry of the particular system. Approaches for writing software for embedded systems can include bare-metal programming and software-based programming. Bare-metal programming can essentially provide for direct execution of the code logic by the processor without any additional software to control the flow of the program. Software-based programming can include leveraging a Real Time Operating System (RTOS) for programming execution of the processor, wherein the RTOS provides scheduling functionalities to execute different pieces of code at a predefined schedule.

Currently, in order to program a microcontroller to initialize and control circuitry external to the microcontroller, software programmers must create detailed and custom programs by hand. In particular, it is not uncommon for programmers to need to understand the overall external circuit operation (e.g., through the use of user manuals, etc.), and such circuit operation typically varies on a circuit-by-circuit basis. As a result, the code written for a particular integrated circuit is typically specific only to that circuit. Such code may require, for example, programming through registers, including initializing register values at the beginning of code execution and using peripheral specific registers to control the operation of the peripherals. Interfacing with the microcontroller peripherals can become even more difficult as the system becomes more complex (e.g., and includes more external components to the microcontroller that need to be interfaced with for microcontroller operation). Further, since there are no programming standards or standardized structures used for such programs, the code cannot be easily ported to other environments or used with other circuits or programs.

While graphical programming environments exist to help guide a user through creating software programs for microcontrollers, such programming environments only facilitate programming of the microcontroller itself: any interaction with external circuitry or peripherals cannot be programmed through the graphical programming environment. Software engineers are therefore left to handle such programming outside of the graphical programming environment, and must create such code by hand according to the specific operation of the circuitry.

The inventor has recognized and appreciated that programming microcontrollers to interface with external circuitry can be simplified by providing a graphical programming environment that allows programmers to easily incorporate pre-packaged code modules (e.g., with dedicated functions for associated integrated circuits) to program a microcontroller to interface with those components. The inventor has also developed improvements to conventional RTOS s that includes a portion of code, such as an abstraction layer or a dedicated thread, that is used to initialize and control a microcontroller's peripherals and/or as external hardware.

In some embodiments, the inventor has developed a graphical programming environment that allows programmers to graphically manage the initialization and/or control of a micro-controller's peripherals and/or external hardware right in the graphical programming environment, including, for example through the use of state machines. Like some conventional graphical programming environments, the graphical programming environment generally allows a user to create a software program that can be complied and executed by a microcontroller. The software program can be designed to control the execution of a microcontroller through state machines, including programming functions, execution states, timers, etc. Unlike conventional graphical programming environments, the techniques also provide for programming the microcontroller's use of external circuitry through the graphical programming environment. In some embodiments, the techniques include providing pre-configured code modules that can be easily added to the program being developed in the graphical programming environment to program the microcontroller to communicate with external circuitry.

In some embodiments, the code created through the graphical programming environment is compiled into an RTOS that leverages an abstraction layer or thread to implement the code associated with the external circuits. In particular, the abstraction layer or thread can be configured to handle most aspects of interfacing with external circuitry, such as initializing the external circuitry, issuing commands, factoring in any necessary timing, and performing any tasks dependent on data returned from the external circuitry. As a result, the application can be configured to simply indicate what operation needs to be performed (e.g., transmitting data), and any operations that need to be executed once the operation is complete, and the abstraction layer or thread can handle the execution and coordination of the operations.

As a result, the techniques described herein can drastically simplify programming microcontrollers to operate with external circuitry, both through the use of an improved RTOS and graphical programming environment. Users can easily create code and state machines through the graphical programming environment for interacting with the external circuitry, which can be as simple as dragging-and-dropping circuit-specific code into a program being developed through the graphical programming environment. In some embodiments, for example, the graphical programming environment can provide a library of supported external circuits (e.g., including specific external circuits by manufacturer, etc., as well as more general external circuit functionality). Programmers can search through the library of available code to find the appropriate code package(s) to leverage for the particular external circuitry of the system. As a result, a user no longer needs to understand the detailed workings and operations of the external circuitry, or to painstakingly write the code line-by-line in order to program a microcontroller to interact with external circuitry.

Following below are more detailed descriptions of various concepts related to, and embodiments of, techniques for automatically mitigating network security threats. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

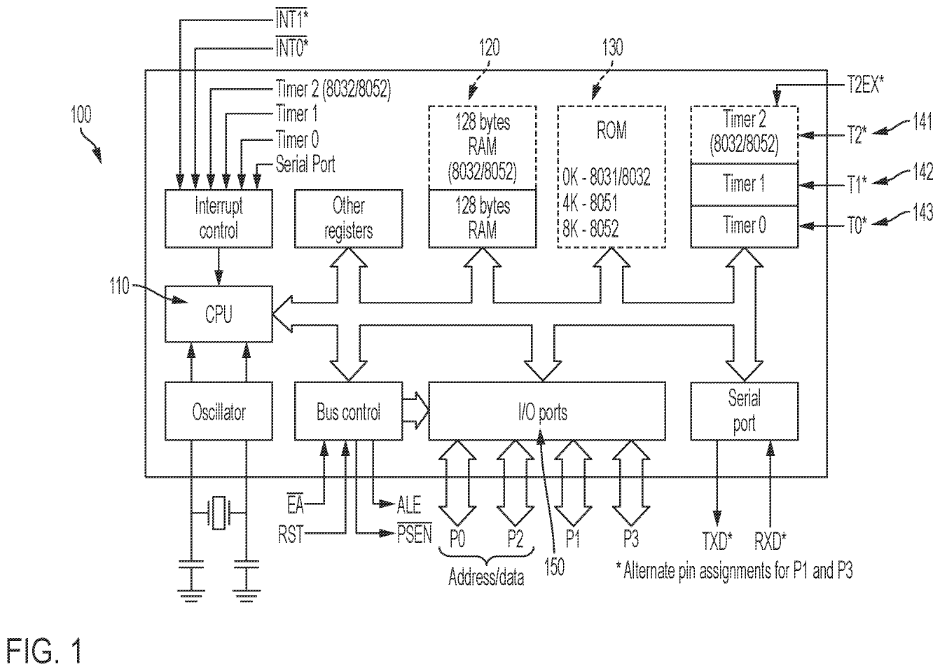

FIG. 1 is a block diagram of an exemplary microcontroller, according to some embodiments. A microcontroller 100 may include one or more central processing units (CPUs) 110 to execute the software. A microcontroller 100 may include a RAM 120, which stores the data that is being processed and/or a ROM 130 which stores the program that is used to process the data. A microcontroller 100 may also include peripherals.

A peripheral may refer to part of a microcontroller that interfaces with the outside world or has a function other than storing data and running program instructions. Peripherals may include pulse width modulators (PWMs), hardware peripherals such as timers (e.g. any of ‘Timer 0’ 143, ‘Timer 1’ 142, and ‘Timer 2’ 141 of FIG. 1), Analog to Digital Converters (ADCs), and/or communication peripherals which can be dedicated to various communication protocols including of Serial Peripheral Interface (SPI), Inter-integrated-circuit (I2C), System Management Bus Server Message Block (SMB), Controller Area Network (CAN), Universal Asynchronous Reception and Transmission (UART), or Universal Synchronous/Asynchronous Receiver/Transmitter (USART).

Some peripherals may be simpler to control than other peripherals, e.g., as a result of having a limited number of modes or states. For example, GPIO peripherals (e.g., that control the state of the microcontroller pins) can have just two states: ‘ON’ or ‘OFF’. In this case, the instructions to change the state of the peripheral may take effect immediately, (e.g., as soon as the user issues the command to change the state of a pin, the state changes, and there is no wait time).

In contrast, other peripherals can be relatively complex and have many internal states. As a result, changing the state of the peripheral might be time consuming, and the application should be able to account for the time that it takes for the peripheral to change the state. Managing these types of peripherals can be difficult and might vary from application to application depending on the project requirements. One example of complex peripheral operations is the use of I2C communication. For example, when an application wants to send some data over the I2C bus, the application typically needs to initialize the peripheral, issue commands to send a specific data over to the receiver, wait for the data transfer to complete, perform the tasks that are dependent on the transfer of that data, and ultimately move on to the next piece of data that should be sent (e.g., resulting in a recurring process).

The inventor has recognized and appreciated that an operating system, such as an RTOS, that includes functions and abstraction layers for such tasks can simplify the task of programming the operation of external circuitry. For example, when an application intends to send some data over the I2C bus, it may push the data to a message queue, and the operating system, according to some embodiments described herein, has the means to fetch the data from the queue, send the data to the proper receiver, and then perform the tasks that depend on the data transfer automatically. For such an example, the application therefore only needs to indicate to the operating system where to send each portion of data and what to do once the data is sent, and the remaining steps required to perform such communication (e.g., initialization, issuance of certain commands, etc.) can be automatically taken care of by the operating system.

Referring further to FIG. 1, the microcontroller may also comprise Input/Output (I/O) ports 150 which are physical pins that are used to electrically connect the microcontroller to external circuitry.

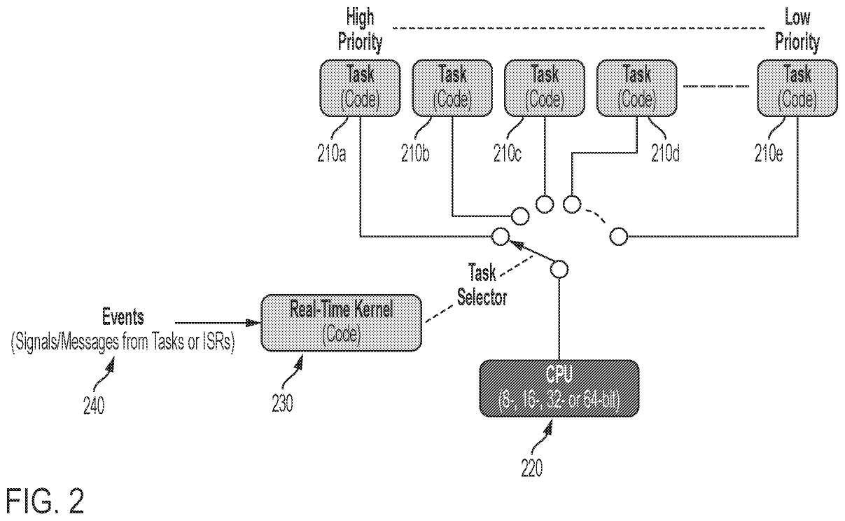

The exemplary microcontroller 100 of FIG. 1 may be used in combination with methods and techniques described further in relation to FIG. 2-13.

FIG. 2 is an exemplary diagram of the operation of a RTOS. As described herein, a software engineer may define one or more tasks, wherein each task may comprise pieces of code that describe, generally, a function that is part of a larger system. Each task may have a different priority. For example, in FIG. 2, tasks 210a-e each comprise code that describe functions that vary in priority. Task 210a, for example, has higher priority than all other tasks such as task 210b, task 210c, task 210d, and task 210e. Task 210e, on the other hand, has lower priority than each of tasks 210a-d.

At any given time, the CPU (e.g., the CPU 110 of FIG. 1) may perform one of the tasks. For example, CPU 220 of FIG. 2 may perform any of tasks 210a-e. A Real-Time kernel (e.g., the Real-Time kernel 230) of an RTOS may be configured to determine, for example, based on events, what tasks the CPU should perform. The events (e.g., events 240) may include signals and/or messages from tasks or interrupt service routines (ISRs).

The operation of a RTOS as shown in FIG. 2 allows users to initialize the RTOS with the correct parameters and then simply call a function that controls the state of external circuitry. For example, in the case of an LED, the state may be ON or OFF. As a result, the RTOS can allow a user to simply call a function to turn the LED to either the ON or OFF state. Such an example is only intended to be limiting, as it should be appreciated that the external circuitry can have many different states that can be controlled accordingly.

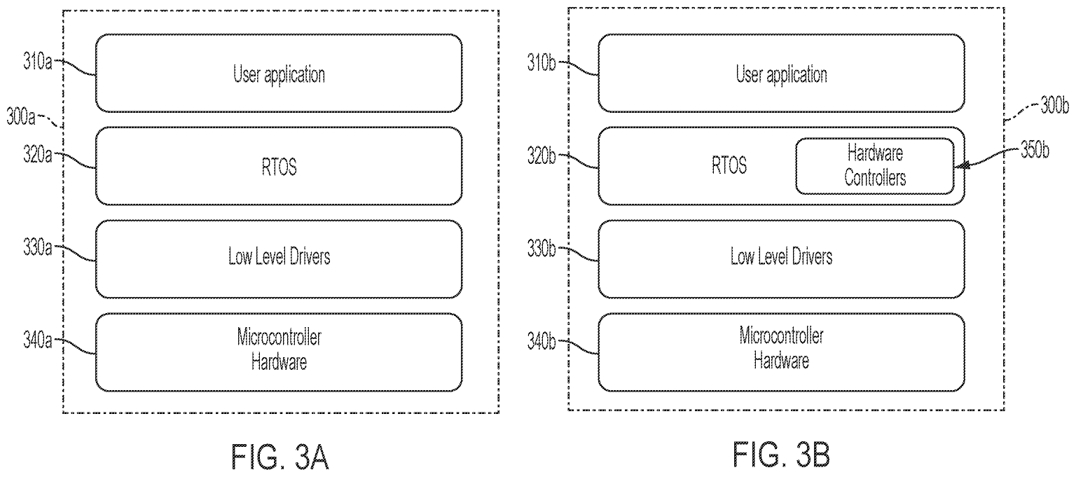

FIG. 3A is an exemplary diagram of an RTOS stack of conventional systems. RTOS stack 300a includes a user application 310a, an RTOS 320a, low level driver 330a, and microcontroller hardware 340a. As described herein, the RTOS 320a may be used to schedule the CPU time for a user application 310a. The low level drivers 330a are responsible for initializing the microcontroller hardware. The low level drivers 330a may sit on top of the microcontroller hardware 340a.

FIG. 3B is an exemplary diagram of an RTOS stack, according to some embodiments. RTOS stack 300b includes a user application 310b, an RTOS 320b, low level driver 330b, and microcontroller hardware 340b. As described herein, the RTOS 320b schedules CPU time for the user application 310b, and the low level driver 330b initializes the microcontroller hardware.

Unlike the conventional RTOS stack 300a, the RTOS stack 300b further comprises hardware controllers 350b within the RTOS 320b. The hardware controllers 350b may include tools such as APIs, threads, and/or drivers necessary to use external circuitry and/or external hardware. This allows the RTOS layer 320b of the RTOS stack 300b of FIG. 3B to perform operations with external circuitry that the RTOS layer 320a of stack 300a otherwise cannot perform. In some embodiments, the operations performed with the external circuitry/hardware may include initialization, control, management, and/or usage of the external circuits/hardware. In some examples, the external circuits/hardware may include one or more integrated circuits (ICs) or any combination of analog and digital circuits. In some cases, the external circuitry/hardware may interact with the processors through GPIO pins or other communication peripherals (e.g., as described in relation to FIG. 1).

According to some embodiments, a processor of a microcontroller (e.g., processor 110 of the microcontroller 100 of FIG. 1) may be configured to run the RTOS 320b. According to some embodiments, the RTOS may comprise a portion of code (e.g., an abstraction layer or thread used to implement the hardware controllers 350b) that causes the processor may communicate with the external circuit to perform one or more operations. The hardware controllers 350b can therefore be used by the RTOS to cause the processor to communicate with external circuitry. As described herein, in some examples, the one or more operations may include initializing the external circuit for operation, controlling a state of the external circuit while the external circuit is running and/or using the external circuit to perform the one or more operations.

In some embodiments, the processor may be in communication with the external circuitry through an I/O pin (e.g., I/O pins 150) and/or through a communication peripheral, including any communication peripheral described with relation to FIG. 1.

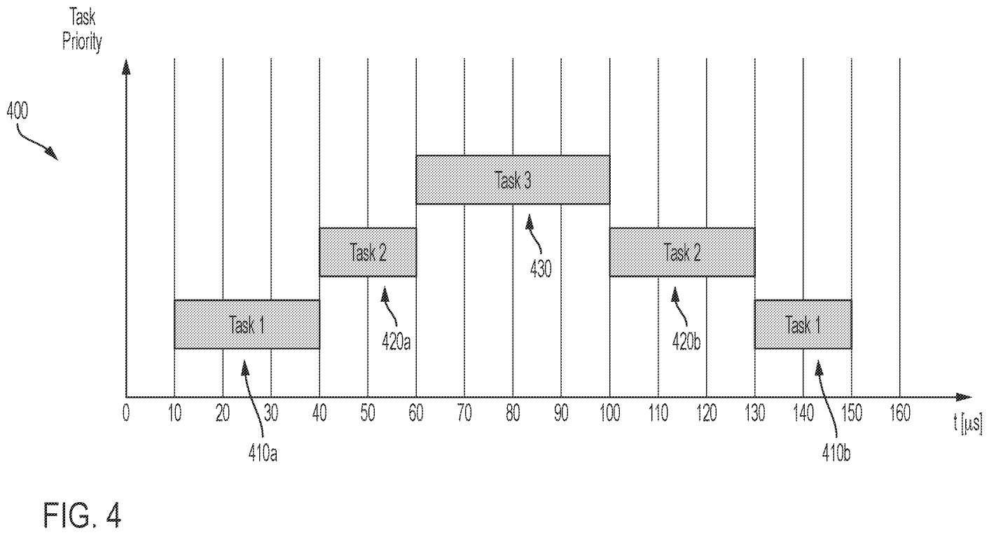

FIG. 4 is an exemplary diagram of preemptive scheduling GUI 400, according to some embodiments. Threads (e.g., tasks) in real time operating systems can be executed according to a predefined schedule. In some cases, the schedule may be defined by the user and can be executed by the RTOS accordingly.

In some embodiments, such a preemptive scheduling GUI 400 can allow a user to specify different parameters of one or more tasks. In some embodiments, the parameters may include how long each of the tasks (threads) are running, the order of task execution, and/or their priorities (e.g., as described in conjunction with the tasks 210 of FIG. 2). In some embodiments, the user may specify these parameters by manipulating one or more aspects of the graphical user interface. For example, the rectangles of FIG. 4, as described further below, may correspond to portions of a task/thread and the user may resize (e.g., to specify the amount of time for the task), and/or move up and down with respect to other rectangles within the chart (e.g., to specify a priority level with respect to other rectangles at other levels). The user may also place the rectangles before or after each other to specify an order of execution. The user may also set a priority of the task.

Returning to FIG. 4, rectangles 410a-b, 420a-b, and 430 in this example are graphical representations of portions of tasks ‘Task 1’, ‘Task 2’, and ‘Task 3’ respectively. In FIG. 4, the tasks are ordered from left to right to indicate the order in which the tasks are to be run. The GUI 400 also configures a priority for each task. For example, ‘Task 3’ 430 has higher priority than ‘Task 1’ 410 and ‘Task 2’ 420, since ‘Task 3’ 430 is arranged higher than ‘Task 1’ 410 and ‘Task 2’ 420. In some examples, a user may manipulate the length of any of the rectangles 410a-b, 420a-b, and 430 in order to indicate that the associated task or thread should run for a longer or shorter period of time. As shown in FIG. 4, for example, portion 410a of ‘Task 1’ runs for 30 microseconds, and portion 410b of ‘Task 1’ runs for 20 microseconds.

According to some embodiments, the GUI can include a component configured to generate code to execute the threads on the microcontroller according to the specifications defined by the user. The GUI may generate code to execute the threads to perform one or more operations on external circuitry, for example, based on user input.

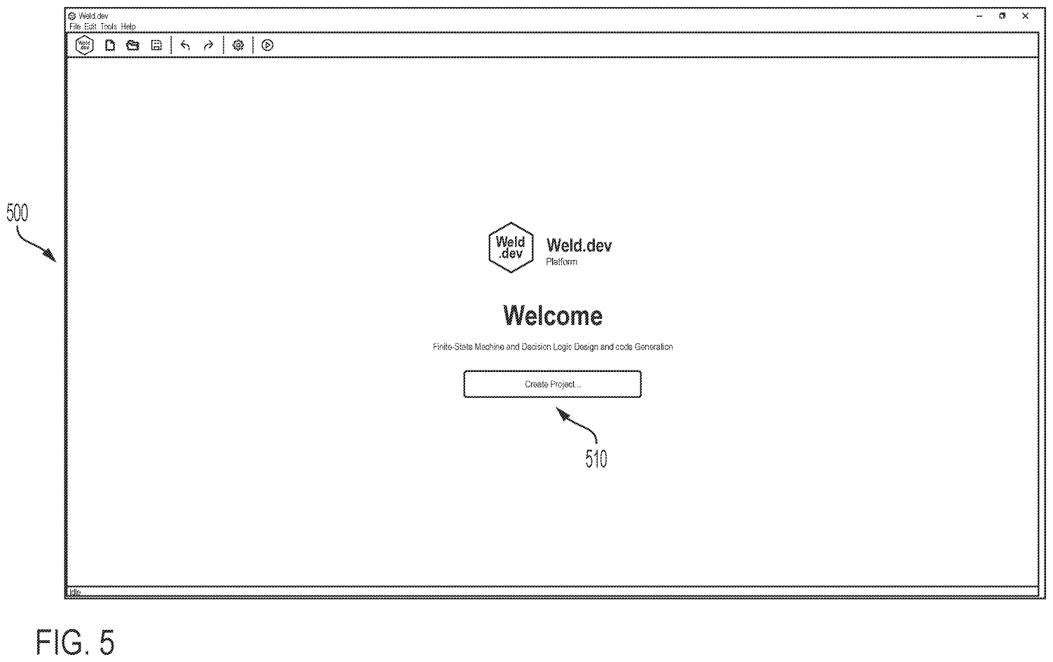

As described herein, the graphical programming environment can allow a user to graphically create a program for execution by a microcontroller. FIG. 5-8 show exemplary windows of an exemplary graphical programming environment implementing some of the aspects described herein, according to some embodiments. FIG. 5 shows an exemplary main page 500 of the graphical programing environment (e.g., which can be the first page displayed to a user upon launching the program). A user of the application may proceed to create a project (e.g., by selecting ‘Create Project . . . ’ 510).

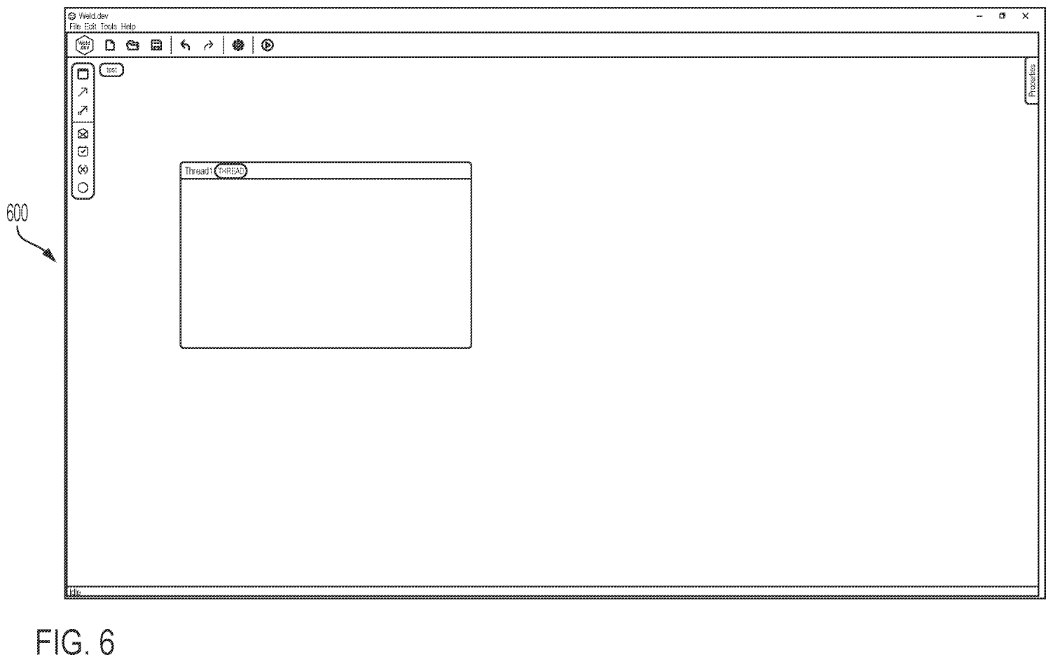

In some examples, creating a project may instantiate the start of a graphical programming project with a default thread. FIG. 6 is an exemplary image of an application window 600, according to some embodiments. The application window 600 may comprise a thread ‘Thread1’ as in FIG. 6. According to some embodiments, a user may graphically design their application within the thread ‘Thread1’. In some examples, the thread may be a default thread. For example, the thread may be instantiated on initializing the application as described herein. However, as described further herein, the graphical programming environment does not limit programs to just one thread, and often multiple threads are created as part of the program.

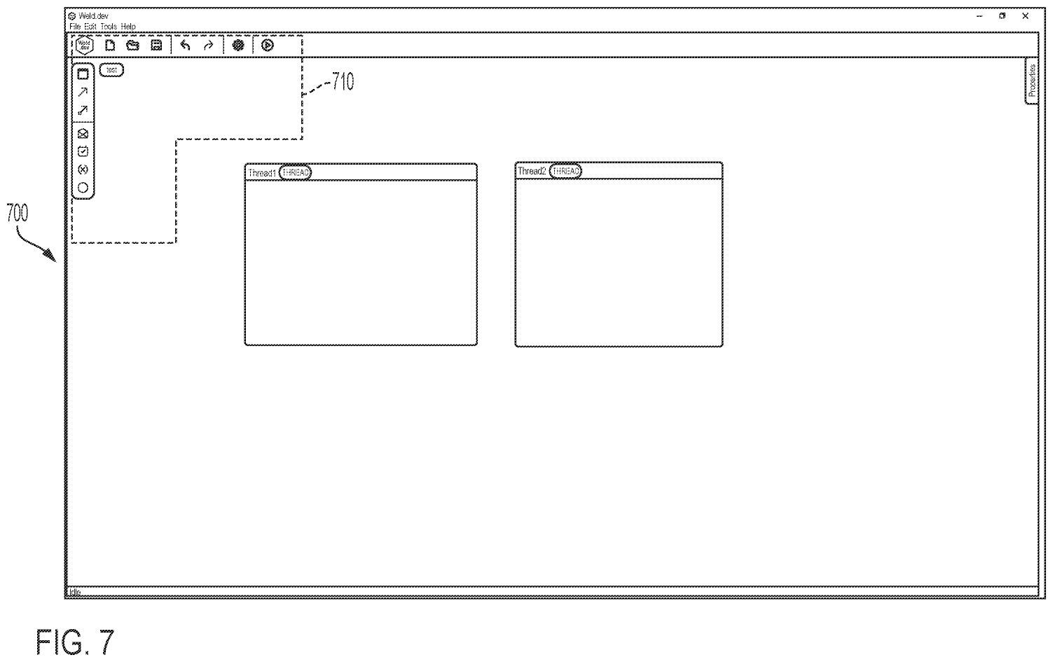

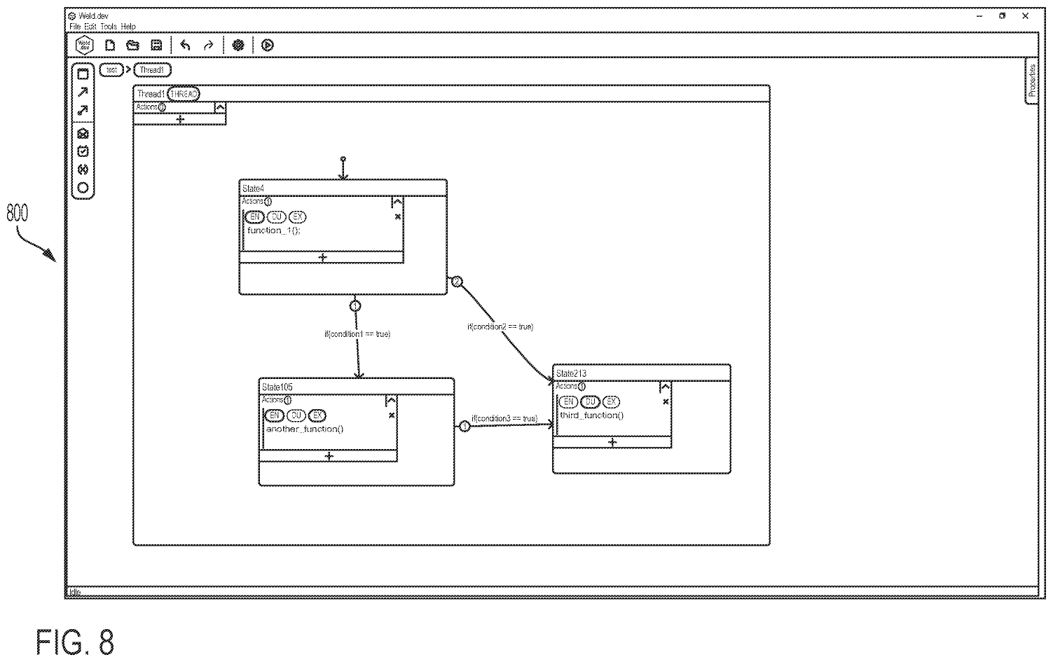

FIG. 7 shows an exemplary image of an application window 700. In FIG. 7, the application window 700 shows two threads, ‘Thread1’ and ‘Thread2’. According to some embodiments, the user can graphically design their application in each of these threads, as desired. FIG. 7 shows a menu 710 on the left. In some examples, a user may add additional threads to the project by dragging and dropping an icon of the menu. In some examples, the user may click on an icon to add additional threads. As further described herein, while not shown, the graphical programming environment can include a library of available threads or programming blocks for external circuitry. The application window 700 may therefore include appropriate user interfaces (e.g., menu items, search bars, etc.) that allow a user to easily search for threads or code modules for external circuitry. FIG. 8 is an exemplary image of an application window 800 showing program details of ‘Thread 1,’ according to some embodiments. As described herein, the application window 800 allows a user to graphically design the aspects of ‘Thread 1’ for the application. According to some embodiments, a thread may comprise states, and transition conditions determining transition between the states. FIG. 8 shows exemplary states ‘State4’, ‘State213’, and ‘State105’ within the thread ‘Thread1’. The states of FIG. 8 have exemplary transition conditions. For example, a transition condition between ‘State4’ and ‘State105’ is defined as ‘if(condition1, true)’ such that if a ‘condition1’ is true, the state will change from ‘State4’ to ‘State105’. As a result, FIG. 8 provides an example of how a user can program various states of a thread, as well as transitions between and among those states.

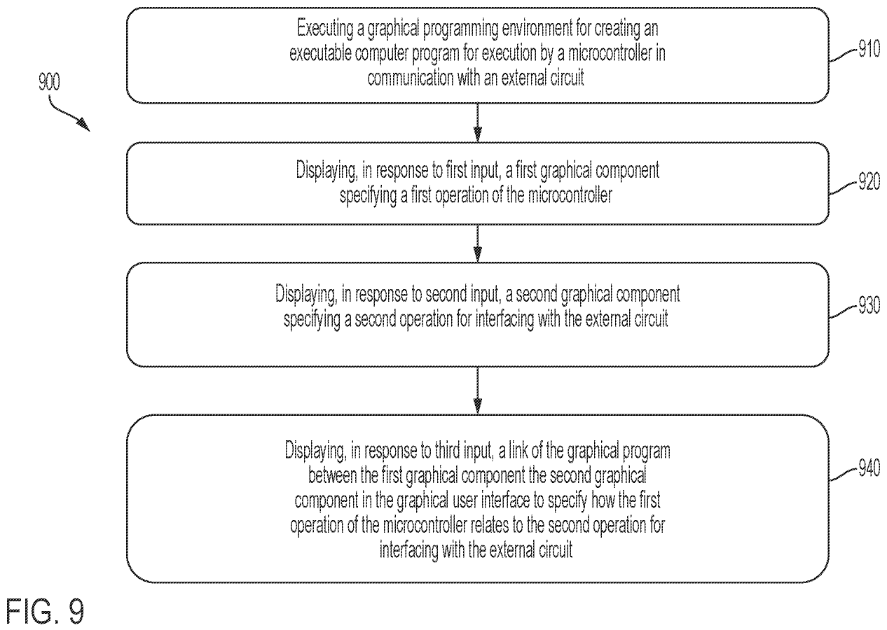

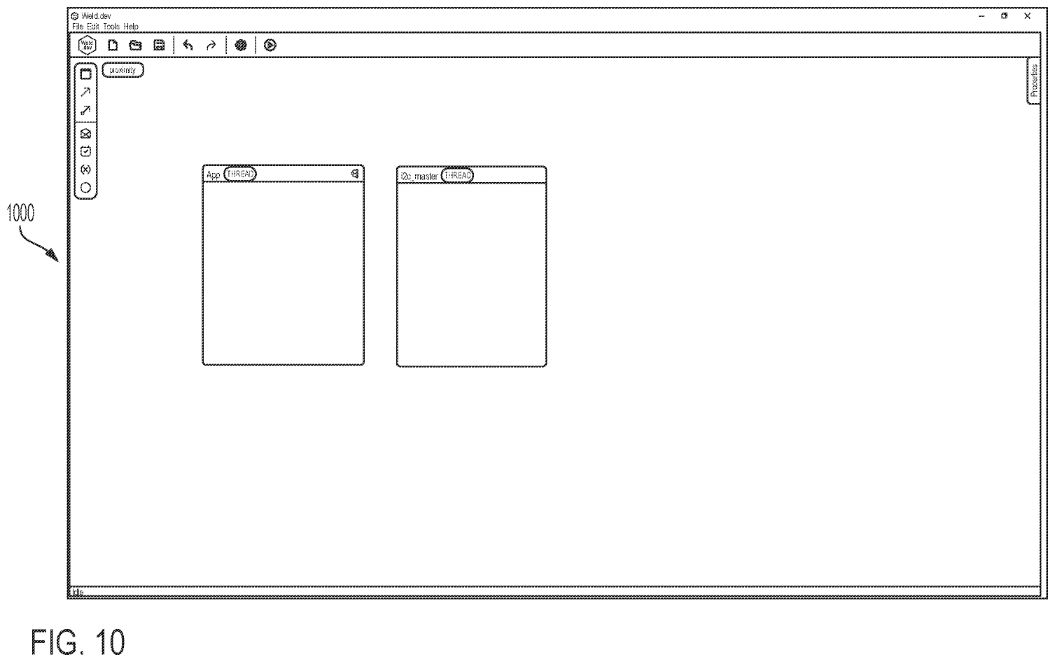

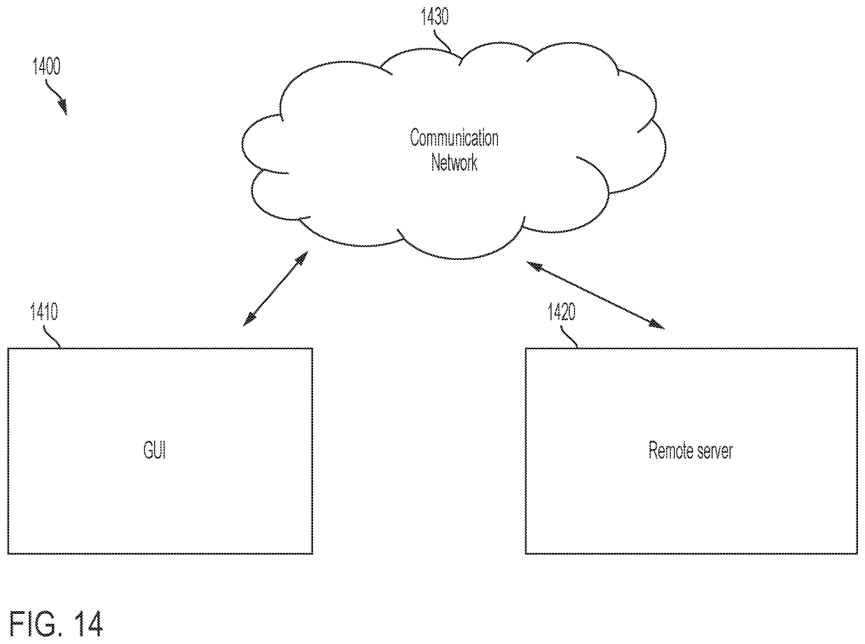

Generally, the graphical programming environment allows a user to graphically specify aspects of a program for both controlling a microcontroller as well as interfacing with external circuitry. FIG. 9 is a flowchart of exemplary computerized method 900 for providing a graphical programming environment for programming a microcontroller, according to some embodiments. At step 910, the computing device (e.g., a remote server and/or user interface executing on a local computing device as described in conjunction with FIG. 14) executes a graphical programming environment for creating an executable computer program for execution by a microcontroller in communication with an external circuit. As described herein, including in conjunction with FIGS. 5-8 and 10-13), the graphical programming environment provides a graphical user interface for graphically specifying at least a portion of the computer program. At step 920, the computing device displays, in response to first input, a first graphical component of a graphical program in the graphical user interface. The first graphical component (e.g., a thread and/or a state block, as discussed in conjunction with FIGS. 5-7) specifies a first operation of the microcontroller. At step 930, the computing device displays, in response to second input, a second graphical component of the graphical program in the graphical user interface. The second graphical component specifies a second operation of the application for interfacing with an external circuit (e.g., as discussed further in conjunction with FIGS. 10-13). The method 900 may also include at step 940 displaying, in response to third input, a link of the graphical program between the first graphical component and the second graphical component in the graphical user interface to specify how the first operation of the microcontroller relates to the second operation for interfacing with the external circuit in step 940.

Some exemplary user interfaces to show creating a graphical program to program a microcontroller to interface with external circuitry is provided in conjunction with FIGS. 10-13, according to some embodiments. FIG. 10 shows an exemplary user interface window 1000 of a graphical programming environment with two exemplary RTOS threads ‘App’ and ‘i2c master’ that a user has created on a project ‘proximity’. In this example, the ‘i2c master’ module allows the microcontroller to initialize and control the I2C communication peripheral of the microcontroller.

In particular, the application thread ‘App’ is a thread the user has created and the application thread ‘i2c master’ is an abstraction for the I2C communication peripheral of a microcontroller that is pre-designed and provided with the RTOS.

In FIG. 10, the two threads ‘App’ and ‘i2c master’ communicate with each other by using a message queue abstraction of the RTOS. The ‘App’ thread sends messages to the ‘i2c master’ thread, asking the ‘i2c master’ thread to initiate specific communications and store the response in some location in the memory. In this example, the App thread is designed by the user and the ‘i2c master’ is pre-designed with the software, but it should be appreciated that the user may change the pre-designed ‘i2c master’ thread from a version provided with the RTOS to suit the needs of the user.

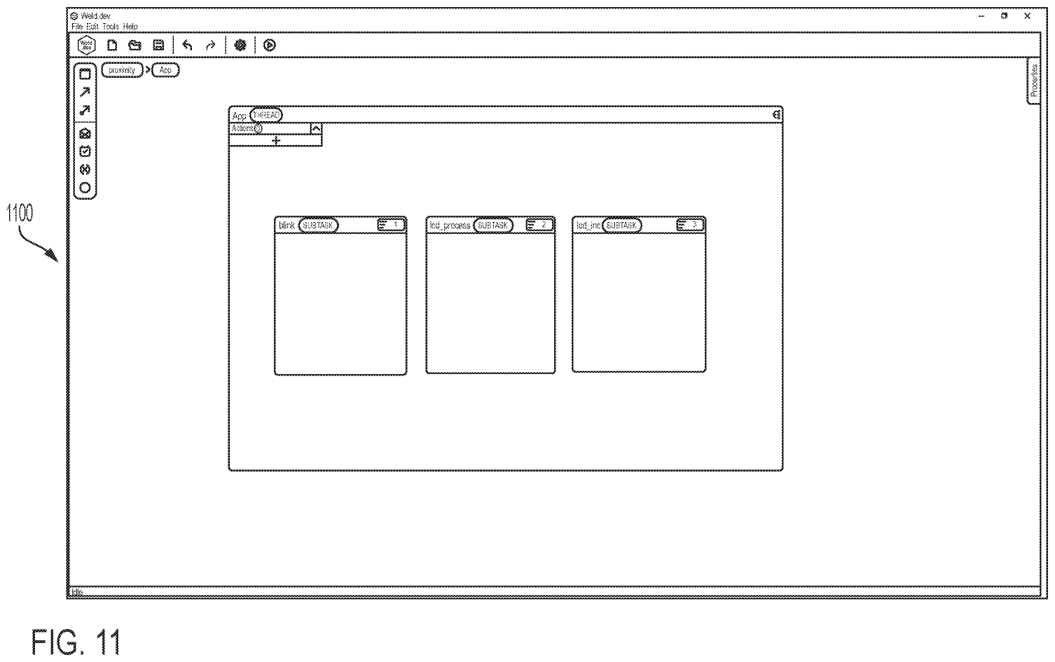

In FIG. 11, the user interface 1100 shows the thread ‘App’ (e.g., ‘App’ of FIG. 10) with three different sub-threads/sub-tasks ‘blink’, ‘lcd_process’ and ‘lcd_inc’. According to some embodiments, the ‘App’ thread may be configured for parallel execution, such that each of the child states of the thread ‘App’ run in parallel. In some embodiments, the sub-threads/sub-tasks are executed one after another.

In this example, the ‘blink’ sub-thread/sub-task of FIG. 11 is configured to cause an LED to blink. The ‘lcd_process’ sub-thread/sub-task is configured to drive the LCD through communication with the ‘i2c master’ thread. The ‘lcd_inc’ sub-thread/sub-task can be implemented by the user. The ‘lcd_process’ sub-thread/sub-task can be pre-designed and shipped with the RTOS.

In some embodiments, the software structure may be nested. For example, a user may implement functionality on the root of the software as a thread and/or the same functionality may be implemented within a thread as a task.

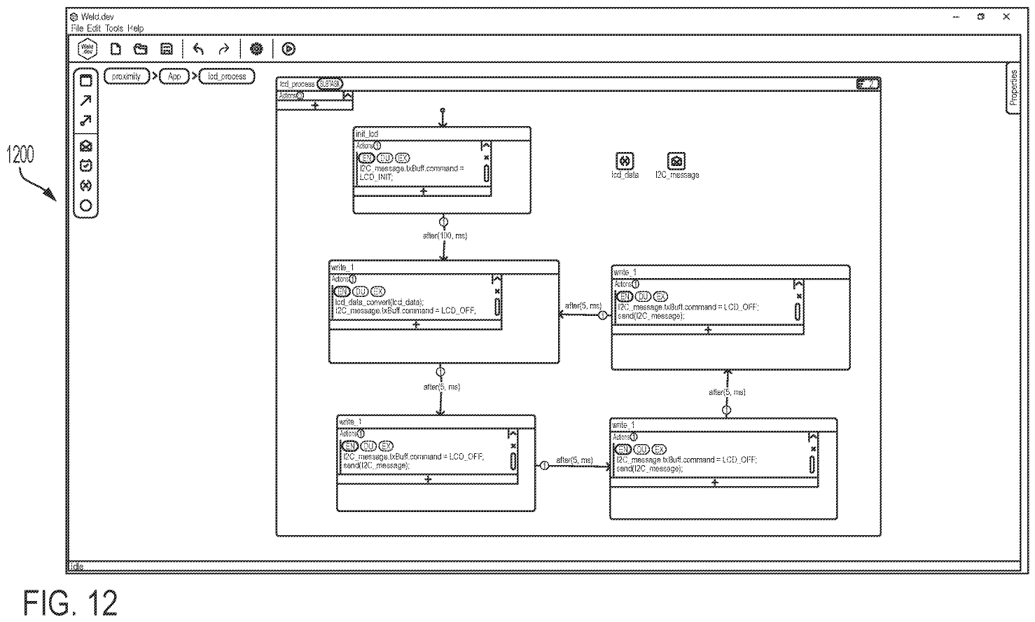

In FIG. 12, the user interface 1200 shows a ‘lcd_process’ module that controls a simple (external) 7-segment LCD and shows a number on the LCD. FIG. 12 shows the abstraction layer for driving the LCD and is implemented using flowcharts. The module controls the LCD by communicating with the i2c master module described in conjunction with FIG. 10. In particular, this can be seen in the blocks within the ‘lcd_process’ module, which includes ‘I2C_message’ calls that call the i2c master to send i2c_messages to the external LCD circuitry via the I2C bus.

As described herein, the user is able to change the abstraction layer aspects shown in FIG. 12, including by adding and/or removing functional blocks, connections between blocks, and/or the like. Once complete and the user moves on to generate the ultimate code, the chart will be converted to code at a code generation step as described herein.

As described herein, the some of the graphical components in the graphical programming environment (e.g., the first and/or second graphical components described in relation to steps 920 and 930 of FIG. 9) can represent states. In some examples, a link of the graphical program between a first graphical component and a second graphical component can be a state transition. Referring to FIG. 12, states ‘init_lcd’ and ‘write_1’ are connected via the state transition ‘after (100, ms),’ which causes the application to proceed from the ‘init_lcd’ state to the ‘write_1’ state after 100 microseconds.

Further, a first and second input can comprise a user clicking, dragging and dropping, typing, programming and/or the like to instantiate new states within the graphical user interface. In some examples a third input could comprise programming a state transition.

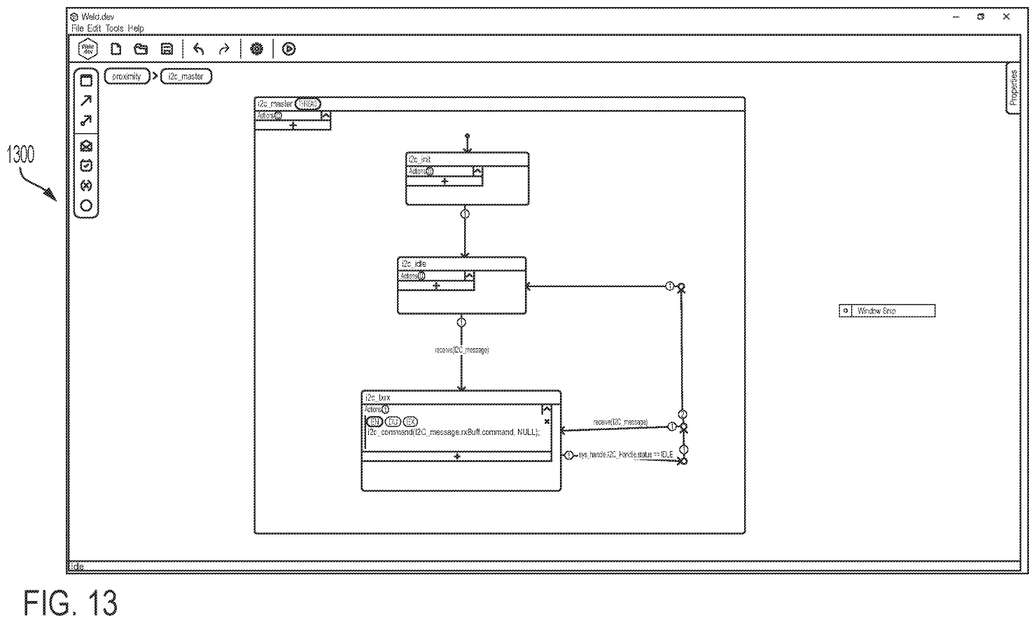

In FIG. 13, the user interface 1300 shows a module that initializes and controls the I2C communication peripheral of the microcontroller. In some examples, the module is the abstraction layer for the I2C communication peripheral and may run commands inside a flowchart. The module ‘i2c master’ comprises states ‘i2c_init,’ ‘12c_idle,’ and ‘i2c_txrx’ and is configured to send and receive i2c_messages to the LCD. The flowchart is converted to code upon code generation, as described herein.

According to some embodiments, a user may select one or more graphical components and threads on the graphical programming interface (e.g., clicking, dragging, etc.) and move, copy, duplicate the one or more graphical components and/or threads. For example, the user may copy a graphical component from one thread into a second thread via the graphical programming interface (e.g., via a click and drag mechanism and/or a cut/copy and paste mechanism). As another example, the user may copy one or more threads (e.g., via click and drag mechanism and/or via cut/copy and paste mechanism) into a project on the graphical programming interface.

Various computing devices and computing configurations can be used to implement the aspects of the techniques described herein. FIG. 14 illustrates a cloud-connected system in which a GUI may communicate with a remote server to perform various operations associated with the techniques described herein. For example, a user can be provided with a user interface to build an executable computer program using a remote server, such as remote server 1420. In particular, FIG. 14 shows system 1400 including GUI 1410 (e.g., which can be executed by a remote user computing device) and remote server 1420, which are connected to, and in communication through, communication network 1430. In some embodiments as described herein, the remote server 1420 may provide a web-based interface to present a graphical programming environment to a user through the GUI 1410. Upon creation of the program, the remote server 1420 can generate, based on the graphical program created via the GUI 1410, an executable computer program for execution by a microcontroller (e.g., microcontroller 100).

In accordance with various embodiments, communication network 1430 may be a local area network (LAN), a cell phone network, a Bluetooth network, the internet, or any other such network. For example, GUI 1410 may be executed on a system positioned in a remote location relative to remote server 1420 such as a separate room, and communication network 1430 may be a LAN. In another example, GUI 1410 may be executed on a system located in a different geographical region from remote server 1420 and may communicate over the internet. It should also be appreciated that the functionality described herein can be implemented using a single computing device (e.g., such that there is no remote server or aspect, and all of the functionality is executed locally to the user). Therefore, it should be appreciated that the techniques are not limited to the embodiment shown in FIG. 14.

According to some embodiments, threads, projects, and/or graphical components may be stored in one or more data structures. The data structures can include, for example, a list, array, table, class, object, and/or any combination. Alternatively or additionally, the threads, projects, and/or graphical components may be stored in one or more files. In some examples, a file may comprise one or more of the data structures and or references to one or more data structures in other files. For example, a project may be stored in a file with one or more data structures corresponding to the different graphical components. In another example, a project may be stored in a file with references to other files storing different graphical components.

In some examples, the files and/or data structures may be stored in a local store and/or database, such as those of a client device on which the graphical programming interface is executed. For example, the client device may be the device on which the GUI of FIG. 4 may be executed and through which a user may graphically create a program for execution by a microcontroller.

Alternatively, the files and/or data structures may be stored on a remote server 1420 or database. A user may use an online platform accessed via the client device to store files and/or data structures of threads, projects, and/or graphical components. For example, the user may select one or more files and/or data structure stored locally on the client device (local store and/or database) and upload the files and/or data structures to a remote server 1420 using the online platform (e.g., via communication network 1430). The user may also use the online platform to access the files and/or data structures (e.g., via communication network 1430). For example, the user may download, from a remote server 1420, the files and/or data structures via the online platform. According to some embodiments, the user may use the online platform to share any files and/or data structures to another user. In some examples, a second user may be able to access and download files and/or data structures uploaded by a first user.

In some embodiments, different versions over time may be stored for a file and/or data structure. For example, a user may store a first version of a project in a file. The user may subsequently update the project. In some embodiments, the user's modification and/or the new updated project may be saved in a new file. In some embodiments, the user's modifications may be saved in the metadata of a pre-existing file for the project.

According to some embodiments, a user may select one or more graphical components, threads and/or projects via the online platform and copy the one or more graphical components, threads and/or projects into the graphical programming interface. For example, the user may copy one or more graphical components (e.g., via click and drag mechanism and/or via cut/copy and paste mechanism) into a project on the graphical programming interface.

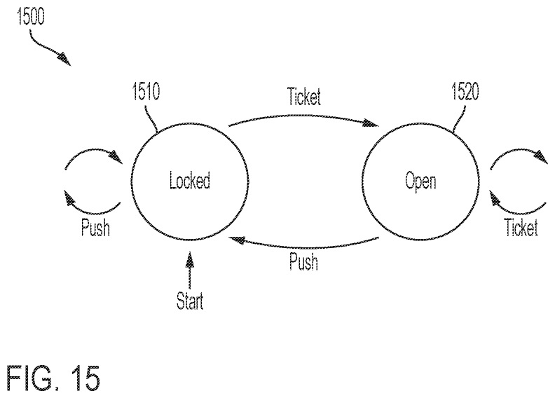

FIG. 15 is an exemplary state machine 1500 of a representation of the operation of a turnstile in a subway, according to some embodiments. The state machine has two states, the ‘Locked’ state 1510 and the ‘Open’ state 1520, with various transition conditions. The state machine of FIG. 15 is a deterministic finite state machine (FSM), but it should be appreciated that any state machine, deterministic and/or non-deterministic may be used.

In some embodiments, UML state diagrams may be used to represent state machines. For example, the UML state diagrams may represent deterministic FSMs that represent the logic of the code of the user. Using UML state diagrams may allow for the user to specify a start transition to denote the initial state to be activated when the state machine executes for the first time, create nested state machines and further divide the code logic and visually create complex decision trees, add transition actions to execute code snippets for given conditions, and/or other aspects of the logic as desired by the user.

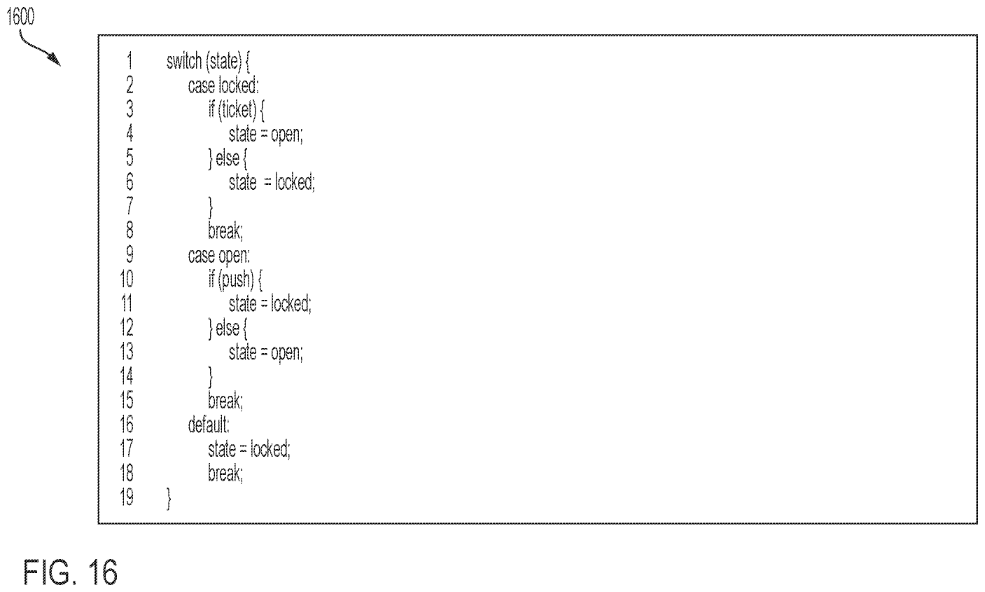

As described herein, state machines created by the user may be used to generate code. For example, FIG. 16 is exemplary code 1600 generated using the state machine 1500 of FIG. 15, according to some embodiments. For example, states corresponding to those in the stat diagram are defined in the code by the same name (e.g., as ‘open’ or ‘locked’) and depending on transition conditions in each state (e.g. ‘ticket’ and ‘push’), the state may change. The arrows extending from and to the states indicate how the code should transition between states. For example, the code may use ‘if’ statements to determine if the state will change.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including”, “comprising”, “having”, “containing” or “involving” and variations thereof herein, is meant to encompass the items listed thereafter and equivalents thereof as well as additional items.

The use of “coupled” or “connected” is meant to refer to circuit elements, or signals, that are either directly linked to one another or through intermediate components.

The terms “approximately”, “substantially,” and “about” may be used to mean within ±20% of a target value in some embodiments, within ±10% of a target value in some embodiments, within ±5% of a target value in some embodiments, and within ±2% of a target value in some embodiments. The terms “approximately” and “about” may include the target value.

What is claimed is:

1. A microcontroller, comprising:
an input/output (I/O) pin in electrical communication with an external circuit; and
a processor in communication with the external circuit through the I/O pin, wherein:
the processor is configured to run a real time operating system; and
the real time operating system comprises a portion of code that causes the processor to communicate with the external circuit through the I/O pin to perform one or more operations with the external circuit.

2. The microcontroller of claim 1, wherein the portion of code comprises:
an abstraction layer that abstracts at least a portion of operation of the external circuit to communicate with the external circuit through the I/O pin to perform the one or more operations;
a thread to communicate with the external circuit through the I/O pin to perform the one or more operations; or a combination thereof.

3. The microcontroller of claim 1, wherein the one or more operations comprises:
initializing the external circuit for operation;
controlling a state of the external circuit while the external circuit is running;
using the external circuit to perform the one or more operations; or a combination thereof.

4. The microcontroller of claim 1, wherein the processor is in communication with the external circuit through an I/O pin.

5. The microcontroller of claim 1, wherein the processor is in communication with the external circuit through a communication peripheral.

6. The microcontroller of claim 5, wherein the communication peripheral implements a communication protocol comprising one of Serial Peripheral Interface (SPI), Inter-integrated-circuit (I2C), System Management Bus (SMB), Controller Area Network (CAN), Universal Asynchronous Reception and Transmission (UART), or Universal Synchronous/Asynchronous Receiver/Transmitter (USART).

7. The microcontroller of claim 1, wherein the portion of code further causes the processor to perform the one or more operations with one or more peripherals of the processor.

8. A non-transitory computer-readable media comprising instructions that, when executed by one or more processors on a computing device, are operable to cause the one or more processors to execute a real time operating system, wherein the real time operating system comprises a portion of code configured to cause the one or more processors to communicate with an external circuit through an I/O pin to perform one or more operations with the external circuit.

9. A method comprising executing a real time operating system, wherein the real time operating system comprises a portion of code configured to cause one or more processors to communicate with an external circuit through an I/O pin to perform one or more operations with the external circuit.

10. A non-transitory computer-readable media comprising instructions that, when executed by one or more processors on a computing device, are operable to cause the one or more processors to execute a portion of code for a real time operating system that configured to cause the processor to communicate with an external circuit through an input/output (I/O) pin to perform one or more operations with the external circuit.

11. A computerized method for execution by a computing device comprising at least one processor and memory configured to store instructions that, when executed by the at least one processor, cause the at least one processor to:
execute a graphical programming environment for creating an executable computer program for execution by a microcontroller in communication with an external circuit, wherein the graphical programming environment comprises a graphical user interface for graphically specifying at least a portion of the computer program;
display, in response to first input, a first graphical component of a graphical program in the graphical user interface, wherein the first graphical component specifies a first operation of the microcontroller;
display, in response to second input, a second graphical component of the graphical program in the graphical user interface, wherein the second graphical component specifies a second operation for interfacing with the external circuit; and
display, in response to third input, a link of the graphical program between the first graphical component the second graphical component in the graphical user interface to specify how the first operation of the microcontroller relates to the second operation for interfacing with the external circuit.

12. The method of claim 11, wherein the user, using the graphical user interface, copies a first graphical component of a graphical program into a second graphical program.

13. The method of claim 11, wherein one or more files and/or data structures storing the first and/or second graphical components are uploaded to a remote server and/or downloaded from the remote server via an online platform.

14. The method of claim 11, further comprising generating, based on the graphical program, human readable code configured to be compiled to generate the executable computer program for execution by the microcontroller, wherein the executable computer program comprises machine code.

15. The method of claim 14, wherein:
a first portion of the executable computer program associated with the first graphical component comprises a first thread;
a second portion of the executable computer program associated with the second graphical component comprises a second thread; or both.

16. The method of claim 14, wherein the executable computer program, when executed by the microcontroller, is configured to generate a real time operating system comprising:
an abstraction layer that abstracts at least a portion of operation of the external circuit to communicate with the external circuit through an I/O pin to perform the one or more operations;
a thread to communicate with the external circuit through the I/O pin to perform the one or more operations; or a combination thereof.

17. The method of claim 14, wherein the executable computer program, when executed by the microcontroller, is configured to cause the processor to interface with the external circuit by performing one or more operations with the external circuit, wherein the one or more operations comprises:
initializing the external circuit for operation;
controlling the one or more operations of the external circuit;
managing a physical aspect of the external circuit;
using the external circuit to perform the one or more operations; or a combination thereof.

18. The method of claim 11, further comprising using a remote server in communication with the graphical programming environment, to generate, based on the graphical program, the executable computer program for execution by the microcontroller.

19. A non-transitory computer-readable media comprising instructions that, when executed by one or more processors on a computing device, are operable to cause the one or more processors to execute a real time operating system comprising:
an abstraction layer that abstracts at least a portion of operation of an external circuit through an I/O pin to perform one or more operations;
a thread to communicate with the external circuit through the I/O pin to perform the one or more operations; or a combination thereof.

20. A system comprising a memory storing instructions, and a processor configured to execute the instructions to execute a real time operating system comprising:
an abstraction layer that abstracts at least a portion of operation of an external circuit through an I/O pin to perform one or more operations;
a thread to communicate with the external circuit through the I/O pin to perform the one or more operations; or a combination thereof.
